(19) United States
(12) Patent Application Publication
(10) Pub. No.: US 2006/0235766 A1
(43) Pub. Date: Oct. 19, 2006

(54) Information processing apparatus and image display program product

(75) Inventors: Eiji Mifune, Osaka-shi (JP); Katsushi Horihata, Osaka-shi (JP); Masayoshi Suzuki, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/374,921

(22) Filed: Mar. 14, 2006

(30) Foreign Application Priority Data
Mar. 18, 2005 (JP) 2005-79792

(51) Int. Cl. G06F 17/30

(52) U.S. Cl. 705/27

(57) ABSTRACT

A display format discriminator discriminates whether a peripheral apparatus detected by a PC is to be displayed as an individual icon or a generic icon representing a group of peripheral apparatuses. A first display controller displays the individual icon or the generic icon based on a discrimination by the display format discriminator. If the generic icon has been designated by an operator, a second display controller displays, the group of peripheral apparatuses in a list associated with the generic icon. If the individual icon has been designated, a main controller controls the peripheral apparatus represented by the individual icon to perform processing necessary for execution of an operation. If, on the other hand, one of the listed peripheral apparatuses has been designated, the main controller controls the designated peripheral apparatus to perform processing necessary for execution of an operation.

### BACKGROUND OF THE INVENTION

1. Field of the Invention

The present invention relates to an information processing apparatus operably connected to a peripheral apparatus, and an image display program product to be executed on the information processing apparatus.

2. Description of the Related Art

Conventionally, a peripheral apparatus such as a printer which is operably connected to an information processing apparatus such as a personal computer (PC) is operative to perform a printing operation by using a printer driver compatible with the printer. Japanese Unexamined Patent Publication No. 2000-112701 discloses a terminal apparatus connected to a network, wherein information acquiring means acquires information concerning peripheral apparatuses connected to the terminal apparatus, and the status of use of the peripheral apparatuses, and display controlling means displays, on a display screen, information concerning the connection of the terminal apparatus to the respective peripheral apparatuses, and the status of use of the peripheral apparatuses on the network, based on the acquired information. In the terminal apparatus recited in the above publication, all the terminal apparatuses and peripheral apparatuses which are communicatively connected to each other on the network are displayed on the screen, which may make an operator feel it cumbersome to operate these peripheral apparatuses on his or her terminal apparatus. The display of all the terminal apparatuses and peripheral apparatuses makes it difficult for the operator to recognize to which peripheral apparatus or apparatuses his or her own terminal apparatus is connected, thereby obstructing the operator from properly operating the peripheral apparatuses.

### SUMMARY OF THE INVENTION

In view of the above problems residing in the prior art, it is an object of the present invention to provide an arrangement that enables to display connected states of an information processing apparatus to peripheral apparatuses in a simplified manner, and enables an operator to readily recognize all the peripheral apparatuses connected to the information processing apparatus for facilitating operations of the peripheral apparatuses.

An aspect of the invention is directed to an information processing apparatus operably connected to at least one peripheral apparatus. The information processing apparatus comprises: an apparatus detector for detecting the peripheral apparatus operably connected to the information processing apparatus; a display format discriminator for discriminating whether the peripheral apparatus detected by the apparatus detector is to be displayed as an individual icon inherent to the peripheral apparatus, or a generic icon representing a group of peripheral apparatuses inclusively with an other detected peripheral apparatus; a first display controller for displaying, on a screen of a display, the individual icon or the generic icon based on a discrimination result by the display format discriminator; a first designation detector for detecting a designation by an operator on one of the individual icon and the generic icon displayed on the screen of the display by the first display controller; a second display controller for displaying, on the screen of the display, the group of the peripheral apparatuses in a list in association with the generic icon if the designation of the generic icon has been detected by the first designation detector; a second designation detector for detecting whether one of the listed peripheral apparatuses has been designated by the operator while the list of the peripheral apparatuses is displayed in association with the generic icon by the second display controller; and a main controller for controlling the peripheral apparatus represented by the individual icon to perform a processing necessary for execution of an operation if the designation of the individual icon has been detected by the first designation detector, and controlling the designated one of the listed peripheral apparatuses to perform a processing necessary for execution of an operation if the one of the listed peripheral apparatuses has been designated by the second designation detector.

With this arrangement, when the apparatus detector detects the peripheral apparatus, the display format discriminator discriminates whether the detected peripheral apparatus is to be displayed as the individual icon or the generic icon inclusively with the other detected peripheral apparatus. Further, the first display controller displays, on the screen of the display, the individual icon or the generic icon in accordance with the discrimination result by the display format discriminator. Accordingly, even if a great number of peripheral apparatuses are connected to the information processing apparatus, the display of the peripheral apparatuses as the generic icon enables to eliminate complex display of the peripheral apparatuses on the screen.

Also, in the above arrangement, when the first designation detector detects that the generic icon has been designated by the operator, the second display controller displays, on the screen of the display, the list of the peripheral apparatuses in association with the generic icon. This enables the operator to integrally recognize all the peripheral apparatuses represented by the generic icon.

Further, in the above arrangement, when the first designation detector detects the designation of the individual icon, or when the second designation detector detects the designation of the one of the listed peripheral apparatuses, the main controller controls the peripheral apparatus represented by the individual icon or the designated one of the listed peripheral apparatuses to perform the processing necessary for execution of the operation. This enables the operator to easily operate the peripheral apparatuses connected to the information processing apparatus.

These and other objects, features and advantages of the present invention will become more apparent upon reading of the following detailed description along with the accompanying drawings.

### BRIEF DESCRIPTION OF THE DRAWINGS

FIG. 1 is an illustration showing a network configuration, in which an information processing apparatus as an embodiment of the invention is connected to an image forming apparatus as an example of a peripheral apparatus on a network.

FIG. 2 is a block diagram showing mechanical and functional arrangements of a personal computer, as an example of the information processing apparatus of the embodiment of the invention.

FIG. 3 is a flowchart showing a first embodiment of displaying individual icons and a generic icon by the personal computer.

FIG. 4 is an illustration showing an example of a screen image of a display where individual icons and a generic icon are displayed.

FIG. 5 is a flowchart showing a second embodiment of displaying individual icons and a generic icon by the personal computer.

FIG. 6 is a flowchart showing a processing flow in controlling an operation of the image forming apparatus by the personal computer.

FIG. 7 is an illustration showing an example of a screen image of the display when a list of image forming apparatuses is displayed in association with a generic icon.

FIG. 8 is a flowchart showing a processing flow in switching over display of icon from a generic icon to an individual icon.

FIG. 9 is an illustration showing an example of a screen image of the display in the case where one of the listed image forming apparatuses displayed in association with a generic icon is displayed as an individual icon.

### DETAILED DESCRIPTION OF THE PREFERRED EMBODIMENTS

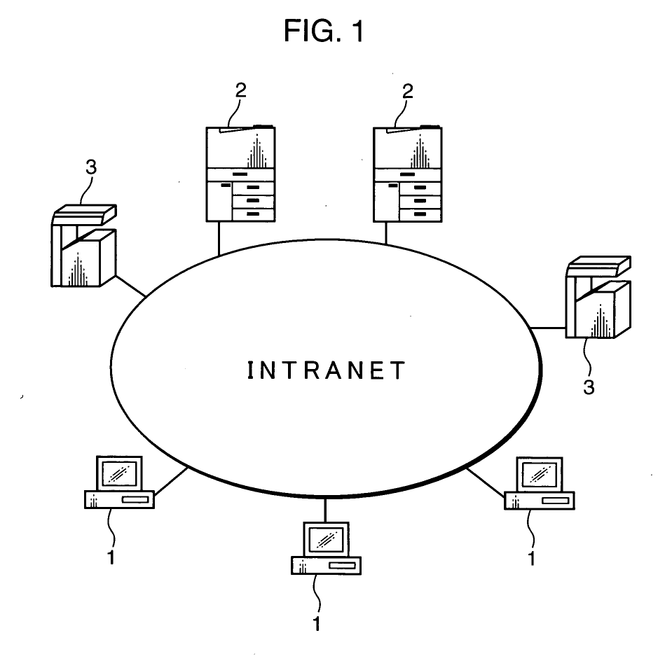

In the following, an embodiment of the invention is described referring to the drawings. FIG. 1 is an illustration showing a network connection status of an information processing apparatus according to an embodiment of the invention to an image forming apparatus as an example of a peripheral apparatus. Personal computers (PCs) 1, serving as the information processing apparatus of the invention, are each communicatively connected to printers 2 and complex machines 3 on an intranet so that data to be printed is sent from each PC 1 to an intended printer 2 or to an intended complex machine 3 for printing. The complex machine 3 is a copying machine provided with functions of a printer and a scanner. The number of the PC 1, the printer 2, and the complex machine 3 connectable on the intranet can be arbitrarily set. Hereinafter, the printers and the complex machines are generally called as “image forming apparatus”.

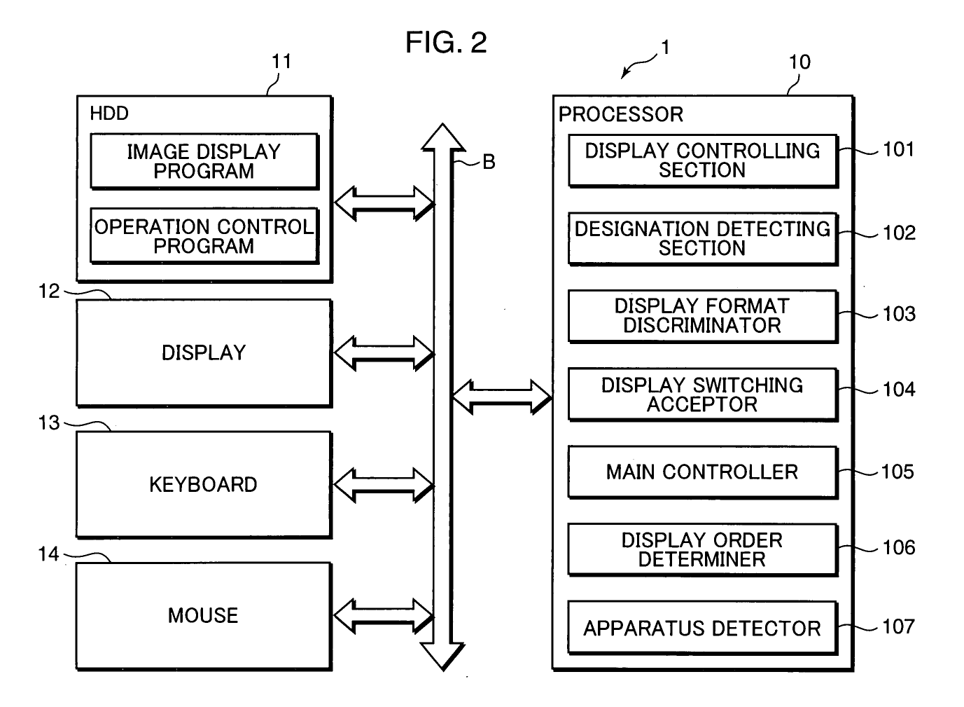

FIG. 2 is a block diagram showing mechanical and functional arrangements of the PC 1 according to the embodiment of the invention. The PC 1 mechanically includes a bus B, a processor 10, a hard disk drive (HDD) 11, a display 12, a keyboard 13, and a mouse 14. The processor 10 reads out a program stored in the HDD 11, and has a central processing unit (CPU) and a random access memory (RAM).

The HDD 11 is a non-volatile storage for storing, on a magnetic disk, various programs e.g. an operation control program to be executed on the PC 1. The HDD 11 also stores an image display program of the invention. The PC 1 is functioned as the information processing apparatus of the invention by controlling the processor 10 to operate in accordance with the image display program. The display 12, the keyboard 13, and the mouse 14 constitute a user interface provided on the PC 1. The display 12 is an output device for displaying images, characters, and the like. The keyboard 13 is an input device for allowing an operator to input characters and the like. The mouse 14 is a pointing apparatus for allowing the operator to designate an icon or a like indication displayed on the display 12.

The processor 10 functions as a display controlling section 101, a designation detecting section 102, a display format discriminator 103, a display switching acceptor 104, a main controller 105, a display order determiner 106, and an apparatus detector 107.

The display controlling section 101,which corresponds to a first display controller and a second display controller, is adapted to control display on a screen of the display 12. For instance, the display controlling section 101 displays an image forming apparatus detected by the apparatus detector 107 on the screen of the display 12 in the form of an individual icon or a generic icon based on a discrimination result by the display format discriminator 103. The individual icon is an icon inherent to each image forming apparatus for displaying the image forming apparatuses detected by the apparatus detector 107 individually. One individual icon represents one image forming apparatus. The generic icon is an icon for inclusively displaying a group of image forming apparatuses detected by the apparatus detector 107.

In the case where the designation detecting section 102 detects that the generic icon has been designated by operator's manipulation of the mouse 14 or the like, the display controlling section 101 displays, on the screen of the display 12, a list of the image forming apparatuses inclusively in association with the generic icon. Also, in the case where the operator designates one of the listed image forming apparatuses which the operator intends to display as an individual icon, and the designation is accepted by the display switching acceptor 104, the display controlling section 101 causes the display 12 to newly display an individual icon representing the designated image forming apparatus, and erases the display of the designated image forming apparatus from the list. Also, the display controlling section 101 causes the display 12 to display the individual icons in the order determined by the display order determiner 106.

The designation detecting section 102, which corresponds to a first designation detector and a second designation detector, detects whether the individual icon or the generic icon displayed on the screen of the display 12 has been designated by operator's manipulation of the mouse 14, and also detects whether one of the listed image forming apparatuses displayed in association with the generic icon has been designated by the operator while the list of the image forming apparatuses is displayed in association with the generic icon.

The display format discriminator 103 discriminates whether the image forming apparatus detected by the apparatus detector 107 is to be displayed as the individual icon, or as the generic icon inclusively with the other detected image forming apparatus or apparatuses.

The display switching acceptor 104 accepts designation by the operator to display a designated one of the listed image forming apparatuses, as an individual icon, while the list of the image forming apparatuses is displayed in association with the generic icon.

The main controller 105 controls an overall operation of the PC 1. In the case where designation of an individual icon representing an image forming apparatus has been detected by the designation detecting section 102, the main controller 105 controls the designated image forming apparatus to perform processing necessary for executing a printing operation. On the other hand, in the case where designation of one of the listed image forming apparatuses has been detected by the designation detecting section 102, the main controller 105 controls the designated image forming apparatus to perform processing necessary for executing a printing operation.

The display order determiner 106 determines the order of displaying the individual icons representing the image forming apparatuses detected by the apparatus detector 107 on the screen of the display 12 based on the frequency of use e.g. the number of times of using the respective image forming apparatuses during a predetermined period. For instance, the display order determiner 106 determines the order of displaying the individual icons in such a manner that an individual icon representing a most-frequently used image forming apparatus is located at an appropriate position on a left side in a lower right area on the screen of the display 12, with the individual icons representing the other image forming apparatuses being arranged in the order of decreasing the number of times of use.

The apparatus detector 107 detects image forming apparatuses operably connected to the PC 1. For instance, the apparatus detector 107 detects an image forming apparatus which is operably connected to the PC 1 on the intranet to receive data to be printed from the PC 1 for printing.

As mentioned above, the processor 10 is functioned as the display controlling section 101, the designation detecting section 102, the display format discriminator 103, the display switching acceptor 104, the main controller 105, the display order determiner 106, and the apparatus detector 107 in accordance with the image display program stored in the HDD 11. Alternatively, the respective elements 101 through 107 may be constituted of circuits or equivalent elements, individually.

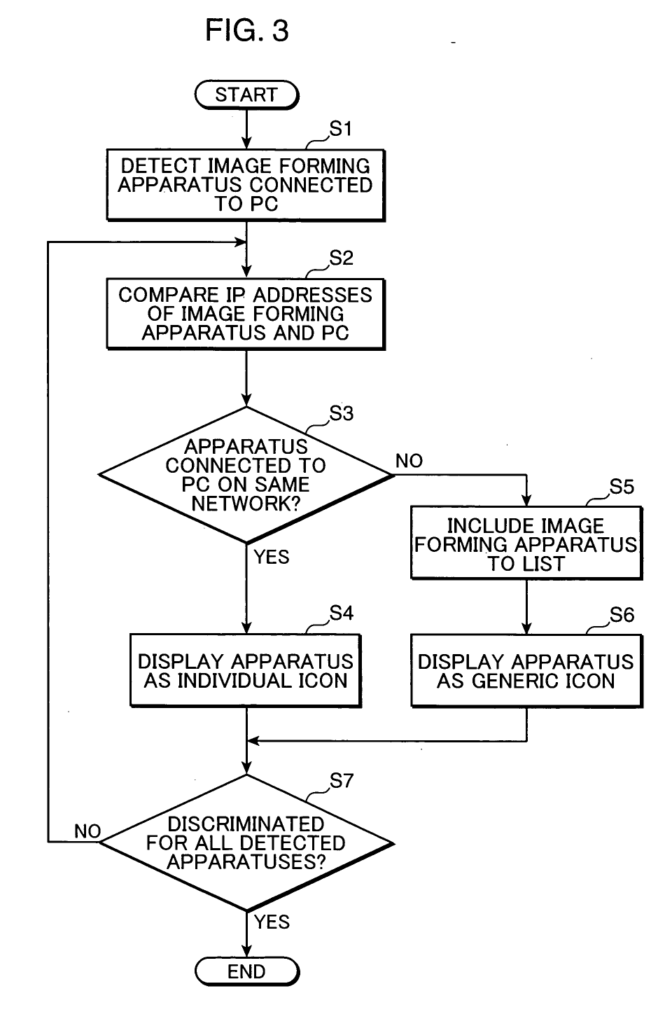

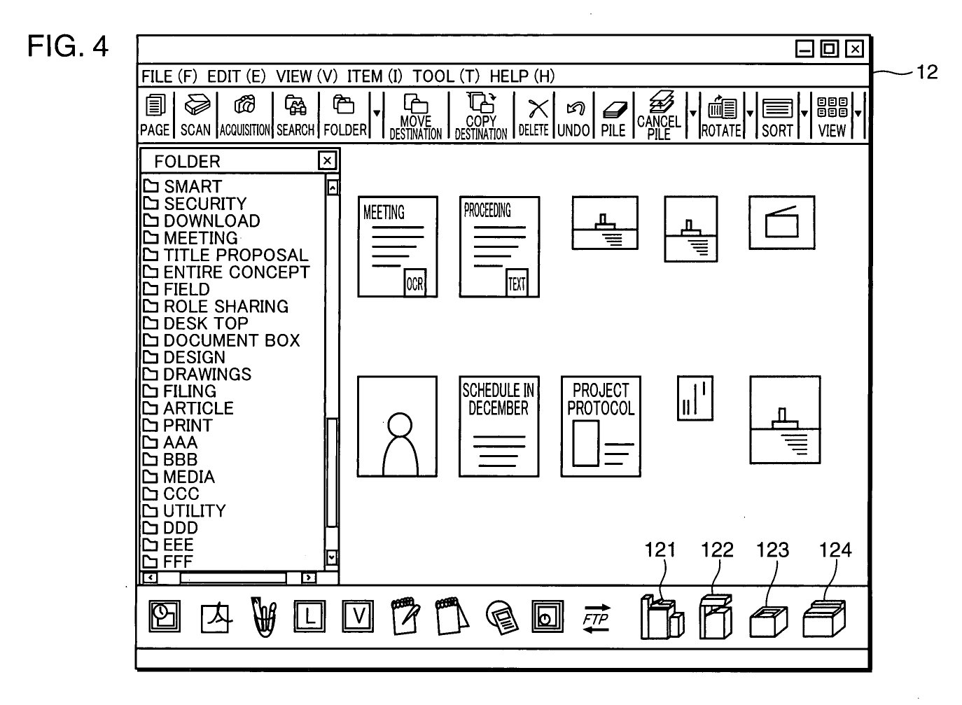

Now, a first embodiment of displaying the individual icons and the generic icon by the PC 1 is described. FIG. 3 is a flowchart showing the first embodiment of displaying the individual icons and the generic icon by the PC 1. FIG. 4 is an illustration showing an example of a screen image of the display 12 where the individual icons and the generic icon are displayed.

First, the apparatus detector 107 detects all the image forming apparatuses which are operably connected to the PC 1 on the intranet to receive data to be printed from the PC 1 for printing (Step S1). For instance, the apparatus detector 107 detects an image forming apparatus which is under the control of the operation control program of the PC 1, as the image forming apparatus operable to print data to be printed which is sent from the PC 1.

Then, the display format discriminator 103 retrieves the IP address of the targeted image forming apparatus detected by the apparatus detector 107 from the operation control program, and compares the IP address of the targeted image forming apparatus with the IP address of the PC 1 (Step S2). In this case, the display format discriminator 103 discriminates whether the targeted image forming apparatus is connected to the PC 1 on the same network by comparing network address portions of the IP addresses of the PC 1 and the targeted image forming apparatus.

If the display format discriminator 103 discriminates that the targeted image forming apparatus is connected to the PC ion the same network (YES in Step S3), the display controlling section 101 controls the display 12 to display on the screen thereof, the targeted image forming apparatus as an individual icon 121, as shown in FIG. 4, for instance (Step S4).

If, on the other hand, the display format discriminator 103 discriminates that the targeted image forming apparatus is not connected to the PC 1 on the same network (NO in Step S3), the display controlling section 101 includes the targeted image forming apparatus in a list of the image forming apparatuses to be displayed as a generic icon, and associates the targeted image forming apparatus with the generic icon so that the list of the image forming apparatuses including the targeted image forming apparatus can be displayed in association with the generic icon (Step S5). Then, the display controlling section 101 controls the display 12 to display, on the screen thereof, the targeted image forming apparatus in a generic icon 124 (Step S6). In other words, the targeted image forming apparatus is not displayed as an individual icon. After Step S6, the display format discriminator 103 cyclically repeats the processing from Step S2 through S6 for all the image forming apparatuses detected by the apparatus detector 107 (Step S7). By implementing the aforementioned processing, as shown in FIG. 4, all the image forming apparatuses connected to the PC 1 on the network are displayed individually as the individual icons 121 through 123, for instance, whereas image forming apparatuses which are not connected to the PC 1 on the same network are displayed in the generic icon 124 representing a group of image forming apparatuses.

In the above processing, the display format discriminator 103 discriminates whether the respective image forming apparatuses are displayed as the individual icons or displayed inclusively as the generic icon based on the IP addresses of the respective image forming apparatuses. Alternatively, in place of using the IP addresses, the frequency of use of the respective image forming apparatuses e.g. the number of times of using the respective image forming apparatuses for a predetermined period e.g. one week may be retrieved, from the PC 1, as criteria data for discrimination, to display the image forming apparatus having the number of times of use equal to or larger than a predetermined reference value e.g. 15 times as an individual icon, and to display the image forming apparatus having the number of times of use smaller than the reference value, in a generic icon. The frequency of use of the respective image forming apparatuses may be acquired from a job history stored in the respective image forming apparatuses, or a log administered by a printer administration system such as SAP™, which is executed on the PC 1.

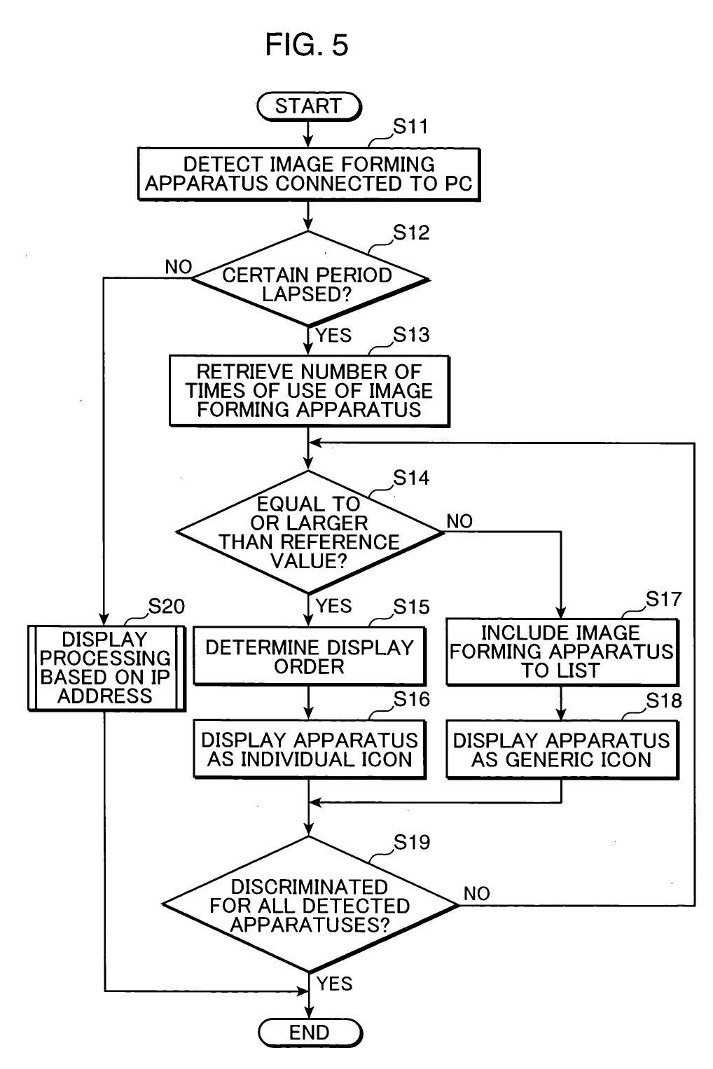

Now, a second embodiment of displaying the individual icons and the generic icon by the PC 1 is described. FIG. 5 is a flowchart showing the second embodiment of displaying the individual icons and the generic icon by the PC 1. The display processing in the second embodiment is substantially the same as the display processing in the first embodiment until a certain period lapses. Specifically, in the second embodiment, upon lapse of the certain period e.g. one week from a first-time discrimination as to whether a targeted image forming apparatus is to be displayed as an individual icon or a generic icon, discrimination as to whether the targeted image forming apparatus is to be displayed as the individual icon or the generic icon is made based on the frequency of use of the image forming apparatus.

First, after the apparatus detector 107 detects an image forming apparatus operably connected to the PC 1 (Step S11), the display format discriminator 103 discriminates whether a certain period has lapsed from the first-time discrimination as to whether the targeted image forming apparatus is to be displayed as the individual icon or the generic icon, based on a count value counted by an unillustrated timer provided in the processor 10 (Step S12). If it is discriminated that the certain period has not lapsed (NO in Step S12), display processing based on the IP address, as in the case of the first embodiment, is performed (Step S20). If, on the other hand, it is discriminated that the certain period has lapsed (YES in Step S12), the display format discriminator 103 retrieves information concerning the number of times of using the image forming apparatus for the certain period from the printer administration system such as SAP, which is executed on the PC 1 (Step S13).

If the display format discriminator 103 discriminates that the number of times of using the image forming apparatus is equal to or larger than the predetermined reference value e.g. 15 times (YES in Step S14), the display order determiner 106 determines the order of displaying the image forming apparatuses based on the number of times of using the respective image forming apparatuses, for instance, displaying the individual icons representing the corresponding respective image forming apparatuses in the order of decreasing the number of times of use, with an individual icon representing a most-frequently used image forming apparatus located at an appropriate position on the left side in the lower right area on the screen of the display 12 (Step S15). Then, the display controlling section 101 controls the display 12 to display the individual icons representing the corresponding respective image forming apparatuses in the order determined by the display order determiner 106 (Step S16).

For instance, if a targeted-image forming apparatus is judged to be displayed as an individual icon, as a result of the first-time discrimination as to whether the targeted image forming apparatus is to be displayed as the individual icon or the generic icon, the targeted image forming apparatus is displayed as the individual icon located at the appropriate position on the left side in the lower right area on the screen of the display 12. Then, if it is judged that a next targeted image forming apparatus has a larger number of times of use than that of the image forming apparatus which is displayed as the leftmost individual icon, the next targeted image forming apparatus is displayed as the leftmost individual icon on the screen, and the previous image forming apparatus which has been displayed as the leftmost individual icon is displayed as an individual icon next to the right of the leftmost individual icon. If, on the other hand, it is judged that the next targeted image forming apparatus has a smaller number of times of use than that of the previous image forming apparatus displayed as the leftmost individual icon, the next targeted image forming apparatus is displayed as the individual icon next to the right of the leftmost individual icon. Thus, the order of displaying the image forming apparatuses is sequentially determined. Thereafter, the display controlling section 101 controls the display 12 to display, on the screen thereof, the individual icons representing the corresponding respective image forming apparatuses in accordance with the order determined by the display order determiner 106.

If, on the other hand, the display format discriminator 103 discriminates that the number of times of use of the targeted image forming apparatus is smaller than the reference value (NO in Step S14), the display controlling section 101 includes the targeted image forming apparatus in the list of the image forming apparatuses to be displayed as the generic icon, and associates the targeted image forming apparatus with the generic icon so that the listed image forming apparatuses including the targeted image forming apparatus can be displayed in association with the generic icon (Step S17). Then, the display controlling section 101 controls the display 12 to display the targeted image forming apparatus in the generic icon (Step S18). The processing from Step S14 through S18 is cyclically repeated for all the image forming apparatuses detected by the apparatus detector 107 (Step S19).

By implementing the above processing, display control is carried out in such a manner that, while storage of the information concerning the number of times of use of the respective image forming apparatuses is insufficient, discrimination as to whether the targeted image forming apparatus is to be displayed as the individual icon or the generic icon is made based on the IP address of the image forming apparatus, and that, once storage of the information concerning the number of times of use of the respective image forming apparatuses is sufficient, discrimination as to whether the targeted image forming apparatus is to be displayed as the individual icon or the generic icon is made based on the number of times of use of the image forming apparatus. This arrangement enables to display the image forming apparatus having a relatively large number of times of use, and accordingly is expected to be frequently used by the operator, as the individual icon, irrespective of a detection result as to whether the image forming apparatus is connected to the PC 1 on the same network. This provides a user-friendly icon display which is flexibly usable by the operator depending on the status of use of the respective image forming apparatuses.

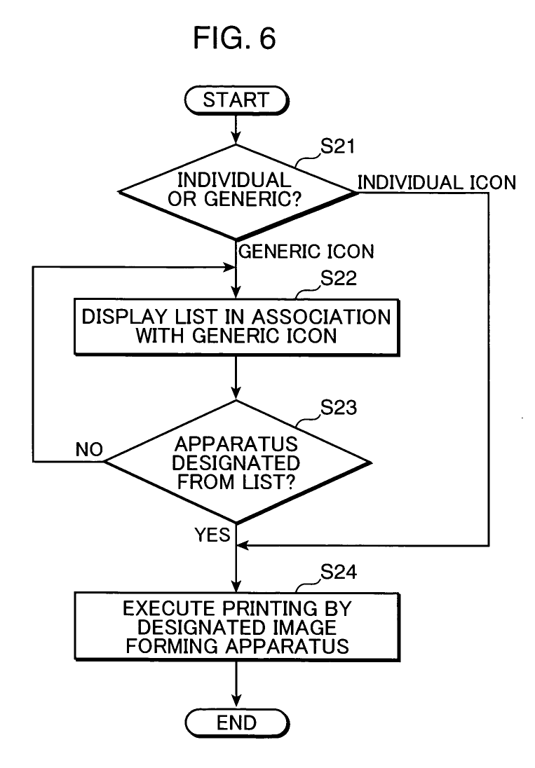

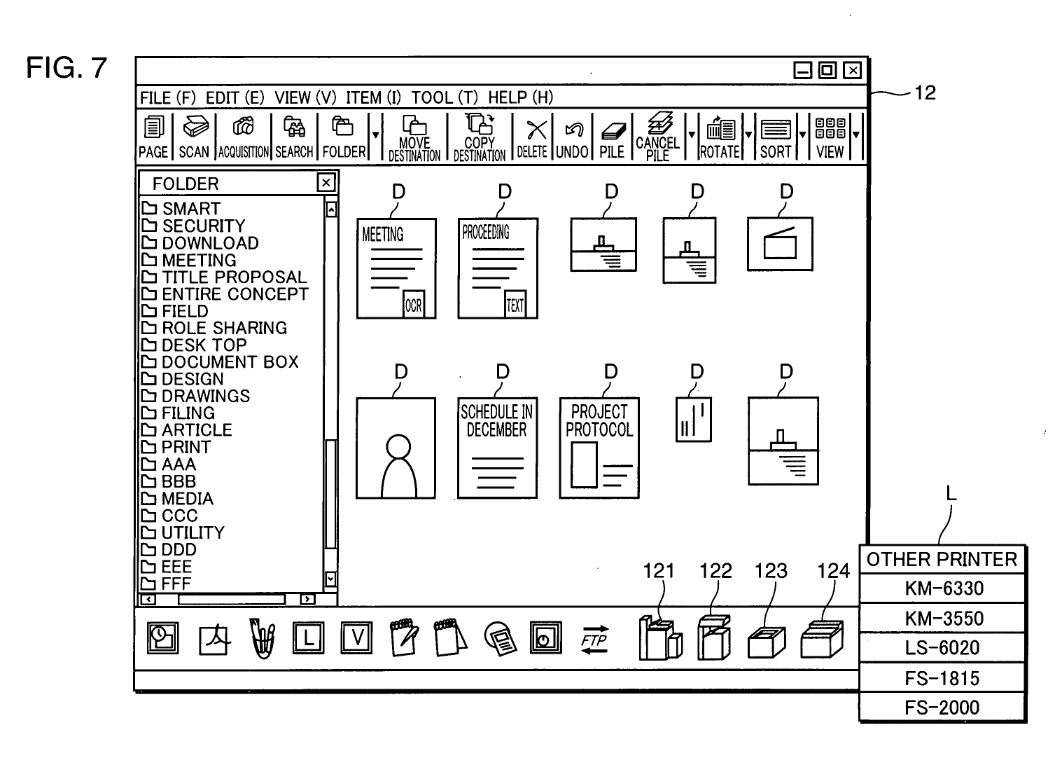

Now, a control operation of the image forming apparatus by the PC 1 is described. FIG. 6 is a flowchart showing a processing flow in controlling an operation of the image forming apparatus by the PC 1. FIG. 7 is an illustration showing an example of a screen image of the display 12 where a list of image forming apparatuses is displayed in association with a generic icon.

In response to operator's designation on a certain individual icon or the generic icon in a state that the individual icons and the generic icon are displayed on the screen of the display 12 by the display controlling section 101, the designation detecting section 102 detects whether the individual icon or the generic icon has been designated (Step S21).

If the designation detecting section 102 detects that the individual icon has been designated (INDIVIDUAL ICON in Step S21), the main controller 105 controls the image forming apparatus represented by the designated individual icon to perform a printing operation (Step S24). For instance, in response to dragging operation of the mouse 14 by the operator to superimpose one of data D displayed as thumbnail images on the screen of the display 12 shown in FIG. 7 over one of the individual icons 121 through 123, the main controller 105 sends the data D to the image forming apparatus represented by the designated individual icon for printing.

If, on the other hand, the designation detecting section 102 detects that the generic icon has been designated (GENERIC ICON in Step S21), as shown in FIG. 7, the display controlling section 101 controls the display 12 to display a list L of image forming apparatuses e.g. printers in association with the generic icon (Step S22). For example, in response to operator's double-click operation on the left part of the mouse 14 while the pointer of the mouse 14 is located on the generic icon 124, the display controlling section 101 controls the display 12 to display the list L on the screen thereof. Then, in response to operator's manipulation of the mouse 14 to designate one of the image forming apparatuses in the list L while the list L is displayed (YES in Step S23), the main controller 105 controls the designated image forming apparatus to perform a printing operation (Step S24). For instance, in response to dragging operation of the mouse 14 by the operator to superimpose one of the data D displayed as the thumbnail images on the screen of the display 12 shown in FIG. 7 over the designated one of the image forming apparatuses displayed in the list L, the main controller 105 sends the data D to the designated image forming apparatus for printing.

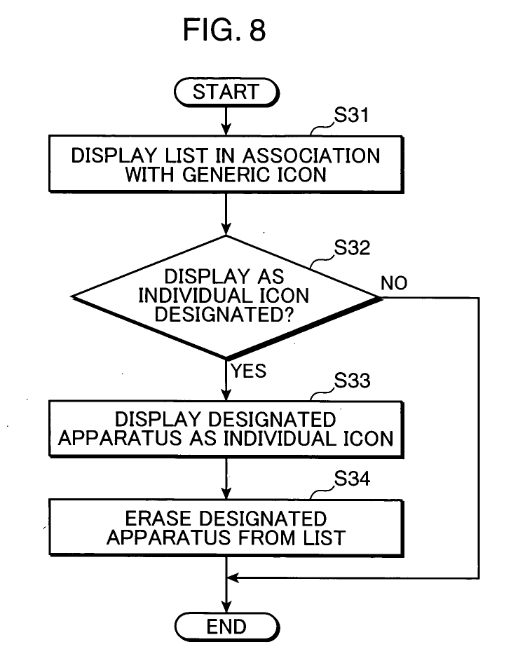

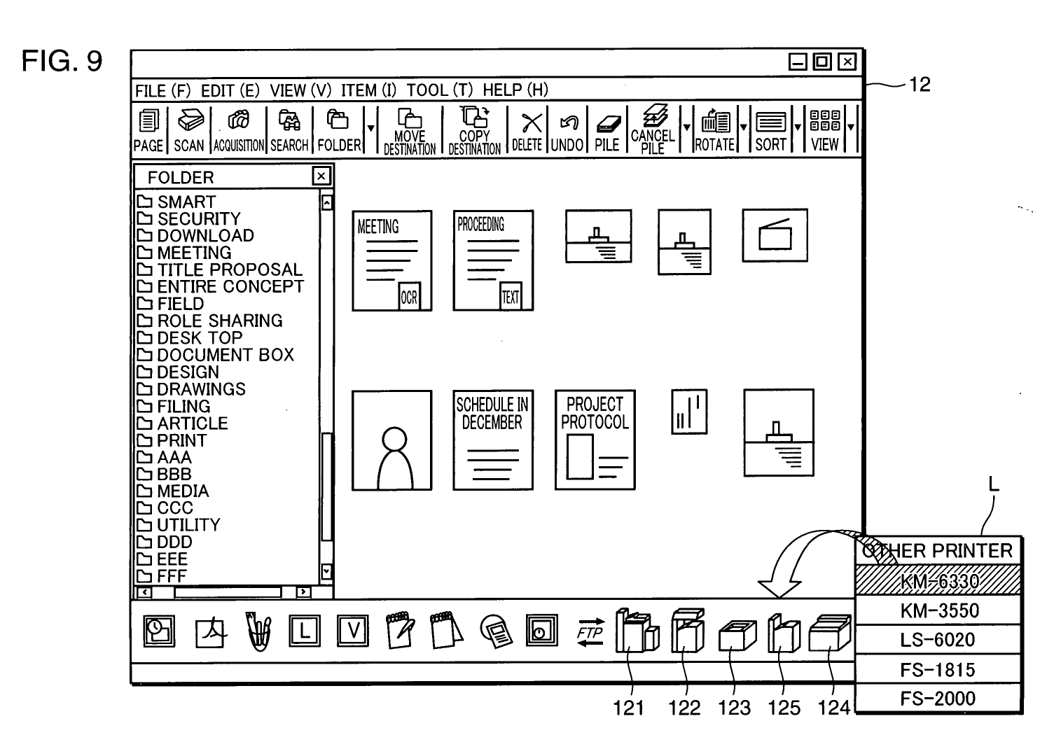

Now, processing for switching over the display of icon from the generic icon to the individual icon is described. FIG. 8 is a flowchart showing a processing flow in switching over the display of icon from the generic icon to the individual icon. FIG. 9 is an illustration of an exemplified screen image of the display 12, showing a state that one of the listed image forming apparatuses displayed in association with the generic icon is about to be displayed as an individual icon.

In response to operator's manipulation of the mouse 14 to designate one of the listed image forming apparatuses for displaying as an individual icon, while the list of the image forming apparatuses is displayed on the screen of the display 12 in association with the generic icon by the display controlling section 101 (Step S31), if the display switching acceptor 104 accepts the designation (YES in Step S32) then, the display controlling section 101 controls the display 12 to display the designated image forming apparatus as the individual icon (Step S33). For instance, as shown in FIG. 9, in response to operator's manipulation of the mouse 14 to designate a complex machine “KM-6330” in the listed image forming apparatuses, and dragging operation of the indication of the complex machine “KM-6330” to a site near the indications of the individual icons 121 through 123, the display controlling section 101 controls the display 12 to display a new individual icon 125 representing the complex machine “KM-6330” on the site where the mouse 14 has been dragged. At the same time, the display controlling section 101 releases the association of the generic icon 124 with the image forming apparatus i.e. the complex machine “KM-6330”, which is now displayed as the individual icon 125, so that the display of the image forming apparatus is erased from the list of the image forming apparatuses displayed in association with the generic icon 124 (Step S34).

In the above display control, the operator is allowed to switch over the display of icon from the generic icon to the individual icon in response to designation of an intended image forming apparatus in the listed image forming apparatuses. This enables to switch over the display of icon according to the operator's need, which provides an improved operability.

The invention is not limited to the foregoing embodiment, but may be modified into various arrangements. In the embodiment, discrimination as to whether a targeted image forming apparatus is to be displayed as an individual icon or a generic icon is made based on the IP address of the image forming apparatus operably connected to the PC 1, or the number of use of the image forming apparatus. Alternatively, the criteria data for the discrimination may be other than the IP addresses, and the number of times of use of the respective image forming apparatuses. For instance, the display format discriminator 103 discriminates whether the targeted image forming apparatus is to be displayed as the individual icon or the generic icon, based on weighting information which is set individually for the respective image forming apparatuses detected by the apparatus detector 107, or after the weighting information is added to the respective image forming apparatuses.

In the above modification, the display format discriminator 103 stores a data table indicating correlations between the respective image forming apparatuses, and weighting points for the respective image forming apparatuses, which are values representing importance of the respective image forming apparatuses on the network. The weighting points for the respective image forming apparatuses detected by the apparatus detector 107 are read out from the data table. If the readout weighting point is equal to or larger than a predetermined reference value, the image forming apparatus having the weighting point is displayed as an individual icon. If, on the other hand, the readout weighting point is smaller than the reference value, the image forming apparatus having the weighting point is displayed as a generic icon.

Further alternatively, after the display format discriminator 103 discriminates whether the targeted image forming apparatus is to be displayed as an individual icon or the generic icon based on the IP address or the number of times of use of the image forming apparatus, the weighting point of the image forming apparatus may be read out from the data table. Then, if the readout weighting point is equal to or larger than the reference value, the targeted image forming apparatus may be displayed as an individual icon irrespective of the IP address or the number of times of use of the image forming apparatus. If, on the other hand, the readout weighting point is smaller than the reference value, the targeted image forming apparatus may be displayed as the generic icon irrespective of the IP address or the number of times of use of the image forming apparatus.

In the embodiment, the printers and the complex machines which are operably connected to the PC 1 are each judged to be displayed as the individual icon or the generic icon. The invention is not limited to the image forming apparatus such as the printers and the complex machines, but may be applicable to a peripheral apparatus e.g. a scanner, as far as the peripheral apparatus is operably connected to the PC 1.

The embodiment of the invention has been exemplarily described by the arrangements and processing shown in FIGS. 1 through 9. The invention, however, is not limited to the arrangements and processing described in the foregoing.

In general, the routines executed to implement the embodiment of the invention, whether implemented as part of an operating system or a specific application, component, program, object, module or sequence of instructions will be referred to as “programs”. The program comprises one or more instructions that are resident at various times in various memories and storage devices in a computer, and that cause the computer to perform the steps necessary to execute steps or elements embodying the various aspects of the invention.

The embodiment of the invention has been and will be described in the context of functioning the computer and computer system. However, those skilled in the art will appreciate that various embodiments of the invention are capable of being distributed as a program product in a variety of forms, and that the invention is applied equally regardless of the particular type of signal bearing media used to actually carry out the distribution. Examples of signal bearing media include but are not limited to recordable type media such as volatile and non-volatile memory devices, floppy and other removable disks, hard disk drives, optical disks (e.g., CD-ROMs, DVDs, etc.), among others, and transmission type media such as digital and analog communication links, including the Internet.

To summarize the invention, an aspect of the invention is directed to an information processing apparatus operably connected to at least one peripheral apparatus. The information processing apparatus comprises: an apparatus detector for detecting the peripheral apparatus operably connected to the information processing apparatus; a display format discriminator for discriminating whether the peripheral apparatus detected by the apparatus detector is to be displayed as an individual icon inherent to the peripheral apparatus, or a generic icon representing a group of peripheral apparatuses inclusively with an other detected peripheral apparatus; a first display controller for displaying, on a screen of a display, the individual icon or the generic icon based on a discrimination result by the display format discriminator; a first designation detector for detecting a designation by an operator on one of the individual icon and the generic icon displayed on the screen of the display by the first display controller; a second display controller for displaying, on the screen of the display, the group of the peripheral apparatuses in a list in association with the generic icon if the designation of the generic icon has been detected by the first designation detector; a second designation detector for detecting whether one of the listed peripheral apparatuses has been designated by the operator while the list of the peripheral apparatuses is displayed in association with the generic icon by the second display controller; and a main controller for controlling the peripheral apparatus represented by the individual icon to perform a processing necessary for execution of an operation if the designation of the individual icon has been detected by the first designation detector, and controlling the designated one of the listed peripheral apparatuses to perform a processing necessary for execution of an operation if the one of the listed peripheral apparatuses has been designated by the second designation detector.

According to the above arrangement, even if a great number of peripheral apparatuses are connected to the information processing apparatus, the display of the peripheral apparatuses as the generic icon enables to eliminate complex display of the peripheral apparatuses on the screen. Also, in response to designation of the generic icon, the list of the peripheral apparatuses is displayed on the screen in association with the generic icon, which enables the operator to integrally recognize the peripheral apparatuses represented by the generic icon. Further, in response to operator's designation of the individual icon or the one of the listed peripheral apparatuses, the designated peripheral apparatus represented by the individual icon or the designated one of the listed peripheral apparatuses is controlled to perform the processing necessary for execution of the operation. This enables the operator to easily operate the peripheral apparatuses connected to the information processing apparatus.

Preferably, the information processing apparatus may further comprise: a display switching acceptor for accepting a designation by the operator to display the designated one of the listed peripheral apparatuses as the individual icon while the list of the peripheral apparatuses is displayed in association with the generic icon by the second display controller, wherein the first display controller newly displays an individual icon representing the peripheral apparatus whose designation has been accepted by the display switching acceptor, and erases the display of the designated peripheral apparatus from the list of the peripheral apparatuses.

According to the above arrangement, since the operator is allowed to designate an intended one of the listed peripheral apparatuses for displaying as the individual icon, the icon display can be flexibly changed according to the user's need, which provides an improved operability.

Preferably, the display format discriminator may discriminate whether the peripheral apparatus detected by the apparatus detector is to be displayed as the individual icon or the generic icon based on an IP address of the peripheral apparatus.

According to the above arrangement, the peripheral apparatus with the IP address having the same network address portion as the network address portion of the IP address of the information processing apparatus can be displayed as the individual icon, and the peripheral apparatus with the IP address having the different network address portion from the network address portion of the IP address of the information processing apparatus can be displayed as the generic icon. This arrangement provides user-friendly icon display, which reflects the status of use of the peripheral apparatuses by the operator.

Preferably, the display format discriminator may discriminate whether the peripheral apparatus detected by the apparatus detector is to be displayed as the individual icon or the generic icon based on a frequency of use of the peripheral apparatus.

According to the above arrangement, the icon display is controlled in such a manner that the peripheral apparatus of high frequency of use can be displayed as the individual icon, and the peripheral apparatus of low frequency of use can be displayed as the generic icon. This arrangement provides user-friendly icon display, which reflects the status of use of the peripheral apparatuses by the operator.

Preferably, the display format discriminator may perform the discrimination as to whether the peripheral apparatus detected by the apparatus detector is to be displayed as the individual icon or the generic icon based on an IP address of the peripheral apparatus until a certain time lapses after a first-time discrimination as to whether the peripheral apparatus is to be displayed as the individual icon or the generic icon, and perform the discrimination upon the lapse of the certain time based on a frequency of use of the peripheral apparatus.

According to the above arrangement, while storage of the information concerning the frequency of use of the respective peripheral apparatuses is insufficient, the respective peripheral apparatuses are displayed on the screen based on the discrimination result as to whether the respective peripheral apparatuses are to be displayed as the individual icon or the generic icon based on the IP addresses of the respective peripheral apparatuses. Thereafter, the display of the icons is sequentially switched over from the individual icon to the generic icon or conversely from the generic icon to the individual icon depending on the frequency of use of the respective peripheral apparatuses. This arrangement provides icon display with an improved operability, which reflects the intended use of the peripheral apparatuses by the operator.

Preferably, the display format discriminator may add weighting information which is set individually for the peripheral apparatus detected by the apparatus detector, and then discriminate whether the peripheral apparatus is to be displayed as the individual icon or the generic icon.

According to the above arrangement, by controlling the setting regarding the weighting information for the respective peripheral apparatuses, for instance, the peripheral apparatus of great importance to the operator or the peripheral apparatus of less importance to the operator can be desirably displayed as the individual icon or the generic icon irrespective of the frequency of use or the IP address of the peripheral apparatus.

Preferably, the information processing apparatus may further comprise: a display order determiner for determining the order of displaying the individual icons based on a frequency of use of the respective peripheral apparatuses detected by the apparatus detector, wherein the first display controller displays the individual icons in the order determined by the display order determiner.

According to the above arrangement, the operator is allowed to readily distinguish the individual icon representing the peripheral apparatus of frequent use from the individual icon representing the peripheral apparatus of less use among the plurality of individual icons displayed on the screen.

Another aspect of the invention is directed to an image display program product for displaying an image. The image display program product comprises: an image display program which causes an information processing apparatus operably connected to at least one peripheral apparatus to function as: an apparatus detector for detecting the peripheral apparatus operably connected to the information processing apparatus; a display format discriminator for discriminating whether the peripheral apparatus detected by the apparatus detector is to be displayed as an individual icon inherent to the peripheral apparatus, or a generic icon representing a group of peripheral apparatuses inclusively with an other detected peripheral apparatus; a first display controller for displaying, on a screen of a display, the individual icon or the generic icon based on a discrimination result by the display format discriminator; a first designation detector for detecting a designation by an operator on the individual icon or the generic icon displayed by the first display controller; a second display controller for displaying, on the screen of the display, the group of the peripheral apparatuses in a list in association with the generic icon if the designation of the generic icon has been detected by the first designation detector; a second designation detector for detecting whether one of the listed peripheral apparatuses has been designated by the operator while the list of the peripheral apparatuses is displayed in association with the generic icon by the second display controller; and a main controller for controlling the peripheral apparatus represented by the individual icon to perform a processing necessary for execution of an operation if the designation of the individual icon has been detected by the first designation detector, and controlling the designated one of the listed peripheral apparatuses to perform a processing necessary for execution of an operation if the one of the listed peripheral apparatuses has been designated by the second designation detector; and a signal bearing media bearing the image display program.

This application is based on Japanese Patent Application No. 2005-79792 filed on Mar. 18, 2005, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An information processing apparatus operably connected to at least one peripheral apparatus, the information processing apparatus comprising:
an apparatus detector for detecting the peripheral apparatus operably connected to the information processing apparatus;
a display format discriminator for discriminating whether the peripheral apparatus detected by the apparatus detector is to be displayed as an individual icon inherent to the peripheral apparatus, or a generic icon representing a group of peripheral apparatuses inclusively with an other detected peripheral apparatus;
a first display controller for displaying, on a screen of a display, the individual icon or the generic icon based on a discrimination result by the display format discriminator;
a first designation detector for detecting a designation by an operator on one of the individual icon and the generic icon displayed on the screen of the display by the first display controller;
a second display controller for displaying, on the screen of the display, the group of the peripheral apparatuses in a list in association with the generic icon if the designation of the generic icon has been detected by the first designation detector;
a second designation detector for detecting whether one of the listed peripheral apparatuses has been designated by the operator while the list of the peripheral apparatuses is displayed in association with the generic icon by the second display controller; and
a main controller for controlling the peripheral apparatus represented by the individual icon to perform a processing necessary for execution of an operation if the designation of the individual icon has been detected by the first designation detector, and controlling the designated one of the listed peripheral apparatuses to perform a processing necessary for execution of an operation if the one of the listed peripheral apparatuses has been designated by the second designation detector.

2. The information processing apparatus according to claim 1, wherein
the display format discriminator discriminates whether the peripheral apparatus detected by the apparatus detector is to be displayed as the individual icon or the generic icon based on an IP address of the peripheral apparatus.

3. The information processing apparatus according to claim 1, wherein
the display format discriminator discriminates whether the peripheral apparatus detected by the apparatus detector is to be displayed as the individual icon or the generic icon based on a frequency of use of the peripheral apparatus.

4. The information processing apparatus according to claim 1, wherein
the display format discriminator performs the discrimination as to whether the peripheral apparatus detected by the apparatus detector is to be displayed as the individual icon or the generic icon based on an IP address of the peripheral apparatus until a certain time lapses after a first-time discrimination as to whether the peripheral apparatus is to be displayed as the individual icon or the generic icon, and performs the discrimination upon the lapse of the certain time based on a frequency of use of the peripheral apparatus.

5. The information processing apparatus according to claim 1, further comprising:
a display switching acceptor for accepting a designation by the operator to display the designated one of the listed peripheral apparatuses as the individual icon while the list of the peripheral apparatuses is displayed in association with the generic icon by the second display controller, wherein
the first display controller newly displays an individual icon representing the peripheral apparatus whose designation has been accepted by the display switching acceptor, and erases the display of the designated peripheral apparatus from the list of the peripheral apparatuses.

6. The information processing apparatus according to claim 1, wherein
the display format discriminator discriminates whether the peripheral apparatus detected by the apparatus detector is to be displayed as the individual icon or the generic icon based on weighting information which is set individually for the peripheral apparatus.

7. The information processing apparatus according to claim 2, wherein
the display format discriminator adds weighting information which is set individually for the peripheral apparatus detected by the apparatus detector, and then discriminates whether the peripheral apparatus is to be displayed as the individual icon or the generic icon.

8. The information processing apparatus according to claim 3, wherein
the display format discriminator adds weighting information which is set individually for the peripheral apparatus detected by the apparatus detector, and then discriminates whether the peripheral apparatus is to be displayed as the individual icon or the generic icon.

9. The information processing apparatus according to claim 1, further comprising:
a display order determiner for determining the order of displaying the individual icons based on a frequency of use of the respective peripheral apparatuses detected by the apparatus detector, wherein
the first display controller displays the individual icons in the order determined by the display order determiner.

10. An image display program product for displaying an image, comprising:
an image display program which causes an information processing apparatus operably connected to at least one peripheral apparatus to function as:
an apparatus detector for detecting the peripheral apparatus operably connected to the information processing apparatus;
a display format discriminator for discriminating whether the peripheral apparatus detected by the apparatus detector is to be displayed as an individual icon inherent to the peripheral apparatus, or a generic icon representing a group of peripheral apparatuses inclusively with an other detected peripheral apparatus;
a first display controller for displaying, on a screen of a display, the individual icon or the generic icon based on a discrimination result by the display format discriminator;
a first designation detector for detecting a designation by an operator on the individual icon or the generic icon displayed by the first display controller;
a second display controller for displaying, on the screen of the display, the group of the peripheral apparatuses in a list in association with the generic icon if the designation of the generic icon has been detected by the first designation detector;
a second designation detector for detecting whether one of the listed peripheral apparatuses has been designated by the operator while the list of the peripheral apparatuses is displayed in association with the generic icon by the second display controller; and
a main controller for controlling the peripheral apparatus represented by the individual icon to perform a processing necessary for execution of an operation if the designation of the individual icon has been detected by the first designation detector, and controlling the designated one of the listed peripheral apparatuses to perform a processing necessary for execution of an operation if the one of the listed peripheral apparatuses has been designated by the second designation detector; and
a signal bearing media bearing the image display program.
